(19) United States
(12) Patent Application Publication
(10) Pub. No.: US 2006/0282841 A1
(43) Pub. Date: Dec. 14, 2006

(54) Disc recording/reproducing apparatus

(75) Inventors: Jeung-rak Lee, Suwon-si (KR); Yong-hoon Lee, Suwon-si (KR); Jae-yong Eum, Suwon-si (KR); Hong-kyun Yim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/354,934

(22) Filed: Feb. 16, 2006

(30) Foreign Application Priority Data
Jun. 8, 2005 (KR) 2005-48812

(51) Int. Cl. G11B 17/04; G11B 17/03; G11B 33/02

(52) U.S. Cl. 720/616

(57) ABSTRACT

A disc recording/reproducing apparatus including a main frame; a tray, mounted to reciprocate on the main frame, having a disc loading part at an upper surface thereof to mount a disc cartridge or a bare disc; a shutter opening/closing unit mounted to the main frame to expose and cover an opening of the disc cartridge according to the reciprocation of the tray; and a cam unit to guide an opening/closing operation part toward the disc loading part when the disc cartridge is loaded on the tray, and to release the guide of the opening/closing operation when the bare disc is loaded on the tray. Alternatively, the disc recording/reproducing apparatus may include a shifting unit to move the opening/closing operation unit toward the disc loading part when the disc cartridge is loaded on the tray, and to separate the opening/closing unit from the disc loading unit when the bare disc is loaded on the tray.

### CROSS-REFERENCE TO RELATED APPLICATION

This application claims the benefit of Korean Application No. 2005-48812, filed Jun. 8, 2005, in the Korean Intellectual Property Office, the disclosure of which is incorporated herein by reference.

### BACKGROUND OF THE INVENTION

1. Field of the Invention

An aspect of the present invention relates to a disc recording/reproducing apparatus, and, more particularly, to a disc recording/reproducing apparatus in which a position of a shutter opening/closing unit may be controlled according to whether a bare disc or a disc cartridge is loaded therein.

2. Description of the Related Art

Generally, disc recording/reproducing apparatuses that record and reproduce information using a disc-type recording medium comprising an optical disc such as a compact disc (CD) and a digital versatile disc (DVD) are widely used to record and reproduce music and images. Such disc recording/reproducing apparatuses are also widely used as storage media of an information processor such as a computer.

In conventional disc recording/reproducing apparatuses, upon loading the disc-type recording medium on a tray, the tray is moved from a withdrawn position to a recording/reproducing position. Then, a turntable, including a rotary driving section, rises from a lower position to drive the recording medium. Here, recording or reproducing of information is performed through moving an optical pickup in a radial direction of the disc-type recording medium.

As the technology surrounding the disc recording/reproducing apparatus comprising an optical disc continues to be advanced towards high density information recording/reproducing, a single-layer optical disc having a capacity of 25 GB has been introduced. However, as high-density disc recording/reproducing apparatuses appear, problems of signal errors by foreign substances such as dust or finger print may be generated. To overcome such problems, an optical disc cartridge is used.

A cartridge case has an opening which is closed by a shutter when not in use and which is opened by the shutter when the cartridge is loaded in the recording/reproducing position in order to perform optical recording/reproducing. Accordingly, the cartridge needs a locking device to maintain the closed state of the shutter, and a shutter opening device to release the closed state of the shutter when the cartridge is loaded on the recording/reproducing position.

FIG. 1 illustrates the structure of a conventional disc recording/reproducing apparatus as is disclosed in Japanese Patent Publication No. 2004-109282. Referring to FIG. 1, the disc recording/reproducing apparatus comprises an outer housing 10, and a tray 13 that moves in and out of the outer housing 10. The tray 13 comprises a recess portion 14 at substantially a center thereof to receive a disc cartridge or a bare disc, and an opening 15 to expose the disc to an optical head.

A shutter opening/closing unit 65 is mounted at one side of the outer housing 10 to open and close a shutter of a disc cartridge (not shown) that is loaded to the tray 13. As the disc cartridge is loaded onto a recording/reproducing position by the tray 13, the shutter opening/closing unit 65 moves in association with the movement of the disc cartridge to open the shutter. On the other hand, as the disc cartridge is unloaded to a withdrawn position by the tray 13, the shutter opening/closing unit 65 operates in association with the disc cartridge to close the shutter.

FIG. 2 is a partially enlarged bottom view showing a bottom of the tray 13 of FIG. 1. Referring to FIG. 2, the shutter opening/closing unit 65 is provided to a side of the outer housing 10 to open and close the shutter of the disc cartridge. The tray 13 includes a cam 85 at a lower surface thereof and a projected patch 86 facing a sliding part of the shutter opening/closing unit 65. The cam 85 separates the shutter opening/closing unit 65 from the disc cartridge. In contrast, the projected patch 86 biases the shutter opening/closing unit 65 toward the cartridge.

In the above-described conventional disc recording/reproducing apparatus, however, the shutter opening/closing unit 65 always operates in the same position, regardless of whether the disc cartridge or the bare disc is loaded. Therefore, a guide part of the shutter opening/closing unit 65 unnecessarily contacts the cam 85 even when the bare disc is used. Such unnecessary contact accelerates an abrasion of the shutter opening/closing unit 65 and, in addition, when foreign substances are delivered to the bare disc through contact with the cam 85, recording/reproducing performance may be deteriorated.

### SUMMARY OF THE INVENTION

An aspect of the present invention is to solve at least the above and/or other problems and disadvantages and to provide at least and/or other advantages as are described below. Accordingly, an aspect of the present invention is to provide a disc recording/reproducing apparatus in which a position of a shutter opening/closing unit may be controlled according to whether a bare disc or a disc cartridge is loaded therein.

In order to achieve the above-described and/or other aspects of the present invention, there is provided a disc recording/reproducing apparatus comprising a main frame; a tray, mounted to reciprocate on the main frame, having a disc loading part at an upper surface thereof to mount a disc cartridge or a bare disc; a shutter opening/closing unit mounted to the main frame to expose and cover an opening of the disc cartridge according to the reciprocation of the tray; and a cam unit to guide an opening/closing operation part toward the disc loading part when the disc cartridge is loaded on the tray, and to release the guide of the opening/closing operation part when the bare disc is loaded on the tray.

The cam unit comprises a guide rib protruded on an upper surface of the tray; a cartridge holder mounted to reciprocate on the tray; a cam slider, connected to the cartridge holder through a fixing unit to move in accordance with the reciprocation of the cartridge holder, having a slider rib corresponding in a position thereof to that of the guide rib; and a guide plate mounted on the upper surface of the tray to guide movement of the cam slider. The fixing unit comprises a fixing projection formed on the cam slider; and fixing ribs formed on a lower part of the cartridge holder to engage with the fixing projection. The cam slider comprises a guide projection at a lower part thereof, and the guide plate comprises a guide hole for insertion and guide of the guide projection. The guide plate has a curve part having a substantially arc form on an inner surface thereof to prevent interference with the bare disc. The cam slider has a curved part having a substantially arc shaped form on an inner surface thereof to prevent an interference with the bare disc. The disc recording/reproducing apparatus may further comprise a resilient member to resiliently bias the cartridge holder on the tray.

According to another aspect of the present invention, there is provided a disc recording/reproducing apparatus comprising a main frame; a tray mounted to reciprocate on the main frame, having a disc loading part at an upper surface thereof, which has a shutter opening/closing part and mounts a disc cartridge or a bare disc; a shutter opening/closing unit to expose and cover an opening of the disc cartridge according to the reciprocation of the tray; and a shifting unit to move the opening/closing operation unit toward the disc loading part when the disc cartridge is loaded on the tray, and to separate the shutter opening/closing unit from the disc loading unit when the bare disc is loaded on the tray.

The shifting unit comprises a cartridge holder mounted to reciprocate on the tray; an arm mounted at a lower part of the cartridge holder to move vertically in accordance with the reciprocation of the cartridge holder; and a lever, supported by the main frame to rotate clockwise and counterclockwise as a result of an interference with the arm in accordance with the reciprocation of the tray, connected at one end thereof to the shutter opening/closing unit. One end of the arm is rotatably mounted on the tray, and the other end is mounted to move vertically in accordance with the reciprocation of the cartridge holder. The cartridge holder comprises a sliding groove to guide the vertical movement of the arm. The disc recording/reproducing apparatus may further comprise a resilient member to resiliently bias the cartridge holder on the tray. The shutter opening/closing unit comprises a slit, and the main frame comprises a catch hook engaged with the slit. The disc recording/reproducing apparatus may further comprise a spring at one side of the lever to resiliently bias the lever inward with respect to the tray.

In the disc recording/reproducing apparatus as described above, the shutter opening/closing unit is selectively moved according to a loading state of a bare disc or a disc cartridge, thereby restraining unnecessary contact between the shutter opening/closing unit and the cam when the bare disc is being used.

Accordingly, abrasion and noise generated between the shutter opening/closing unit and the cam may be reduced. Furthermore, when using the bare disc, foreign substance particles generated by contact between the bare disc and the cam are prevented from being attached to the bare disc, thereby preventing deterioration of the recording/reproducing performance.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing the structure of a conventional disc recording/reproducing apparatus as disclosed in Japanese Patent Publication No. 2003-109282;

FIG. 2 is a partially enlarged bottom view to show a bottom of a tray of FIG. 1;

FIG. 3 is a view schematically showing an embodiment of the present invention;

FIG. 4 is a plan view showing the structure of a disc cartridge loading unit according to the embodiment shown in FIG. 3;

FIG. 5 is a perspective view showing the structure of a disc cartridge loading unit according to the embodiment shown in FIG. 3;

FIG. 6 is an exploded and perspective view showing the structure of a cam unit according to the embodiment shown in FIG. 3;

FIG. 7 is a plan view showing a disc cartridge being loaded on the disc loading unit according to the embodiment shown in FIG. 3;

FIG. 8 is a view showing a cam unit with the disc cartridge removed from FIG. 7, to explain movement of the cam unit in a state that the disc cartridge is loaded;

FIG. 9 is a view showing a disc cartridge being loaded on a tray, according to another embodiment of the present invention;

FIG. 10 is a side view of FIG. 9;

FIG. 11 is a plan view showing a tray with a disc cartridge separated, according to another embodiment of the present invention;

FIG. 12 is a side-sectional view of FIG. 11; and

FIGS. 13 to 15 are views showing operation processes of the tray being loaded with the disc cartridge and entering a main frame.

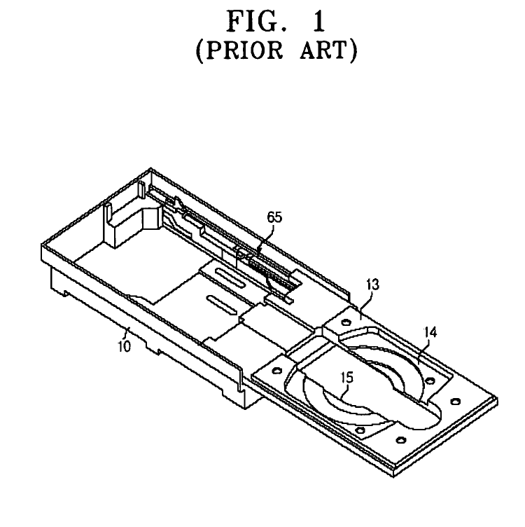

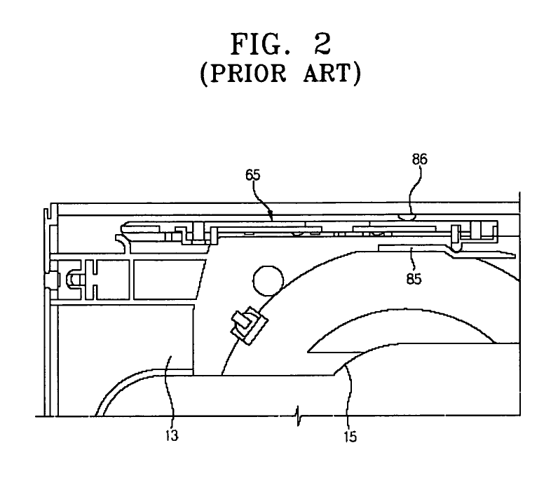

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

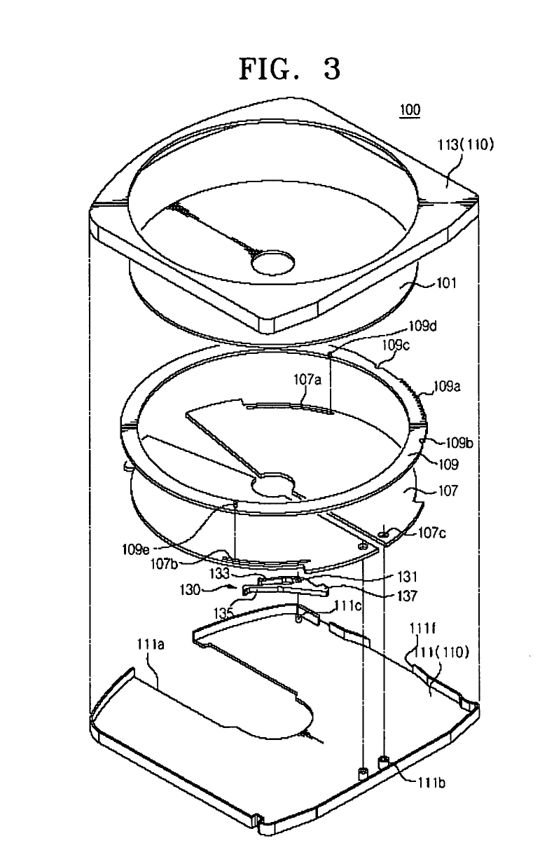

FIG. 3 schematically shows a disc cartridge according to an embodiment of the present invention. Referring to FIG. 3, a disc cartridge 100 houses therein a disc-type recording medium 101 and comprises lower and upper cases 111 and 113, which combine to form a case 110, a shutter 107, and a rotary wheel 109. The lower case 111 has an opening 111a to expose the disc-type recording medium 101 to an optical head (not shown), and a window 111f formed at one side of the lower case 111. The shutter 107 exposes and covers the opening 111a. In particular, the shutter 107 exposes the opening 111a when the disc cartridge 100 is loaded onto a recording/reproducing position.

The rotary wheel 109 opens and closes the shutter 107 as a result of relative movement with a shutter opening/closing unit 250 that will be explained hereinbelow. A segment gear 109a is formed on a rim of the rotary wheel 109, and first and second concave cuts 109b and 109c are formed at a predetermined distance, respectively from both sides of the segment gear 109a. In addition, cam projections 109d and 109e are provided to a bottom of the rotary wheel 109 to open and close the shutter 107 in association with the rotation of the rotary wheel 109. The shutter 107 is provided with cam slits 107a and 107b in which the cam projections 109d and 109e are inserted and slid. The shutter 107 includes a hinge hole 107c through which a support projection 111b formed on the lower case 111 is inserted, so as to operate in an opening and closing manner with respect to the hinge hole 107c according to the rotation of the rotary wheel 109.

A latch unit 130 is formed at one side of the lower case 111 to restrict a rotation of the rotary wheel 109. The latch unit 130 is substantially Y-shape and may be formed by a molding of a synthetic resin. The latch unit 130 comprises a latch hinge hole 131 fit with a hinge shaft 111c of the lower case 111, a resilient arm 133 contacted with a side of the lower case 111, a locking arm 135 locked by the first concave cut 109b, and an unlocking arm 137 releasing the locking arm 135. An end of the unlocking arm 137 is partly exposed to the outside of the case 110.

The structure of the disc cartridge 100 described above is only an exemplary structure to allow for exposing and covering of the opening 111a. Other structures may be applied for the same purpose.

### Embodiment 1

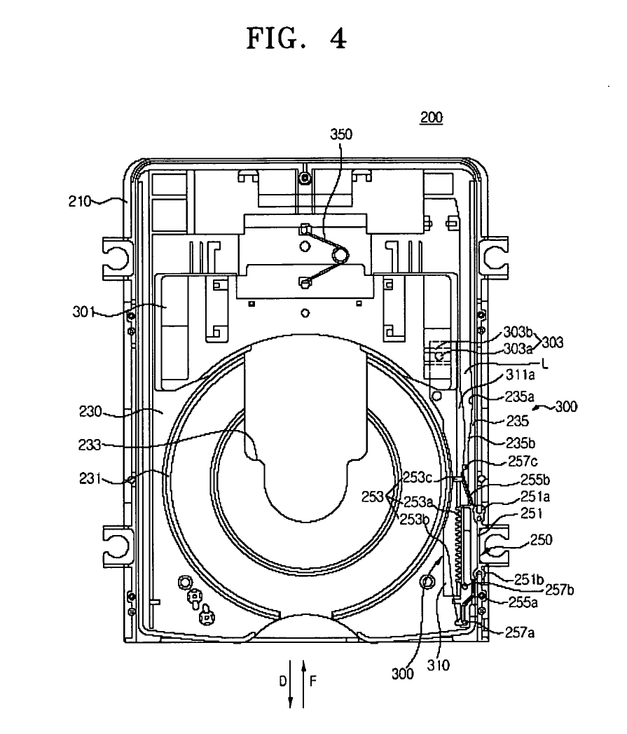

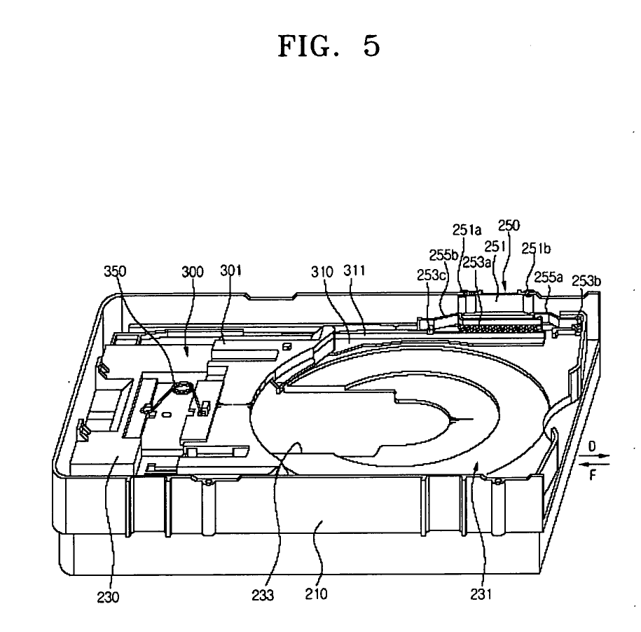

FIGS. 4 and 5 are a plan view showing the structure of a disc cartridge loading unit and a perspective view showing the structure of the disc cartridge loading unit according to an embodiment of the present invention. Referring to FIGS. 4 and 5, a disc cartridge loading unit 200 comprises a main frame 210, a tray 230, and a shutter opening/closing unit 250.

The tray 230 comprises a disc loading part 231 on which the disc cartridge 100 or a bare disc (not shown) is loaded, and a tray opening 233 to expose the bare disc (not shown) or a disc housed in the disc cartridge 100. The tray 230 is supported by the main frame 210 at both sides thereof and is driven linearly by a driving unit (not shown) in directions illustrated by the arrows D and F.

The shutter opening/closing unit 250 comprises a static part 251 fixed at one side of the main frame 210, and an opening/closing operation part 253 that opens and closes the shutter 107 while being interfered with by an operative part of the disc cartridge 100, such as the segment gear 109a, and the first and the second concave cuts 109c and 109d. Here, the opening/closing operation part 253 comprises a rack member 253a meshed with the segment gear 109a of the rotary wheel 109, and first and second shutter opening/closing projections 253b and 253c, which interfere with the first and second concave cuts 109b and 109c and the latch unit 130. The first and the second shutter opening/closing projections 253b and 253c are formed at first and second connection ribs 255a and 255b, which are formed as free ends on both ends of the static part 251, so as to move forward and backward with respect to the disc cartridge 100. The rack member 253a is also formed with a free end and has one side thereof connected to the static part 251 to allow the rack member 253a to move toward and back from the disc cartridge 100. The first and the second connection ribs 255a and 255b, and the rack member 253a are provided with guide projections 257a, 257b, and 257c at single ends thereof, respectively. Fitting parts 251a and 251b are formed on both ends of the static part 251 to engage with a thick portion of the main frame 210. In an embodiment of the invention, the shutter opening/closing unit 250 is formed as one body by molding of synthetic resin.

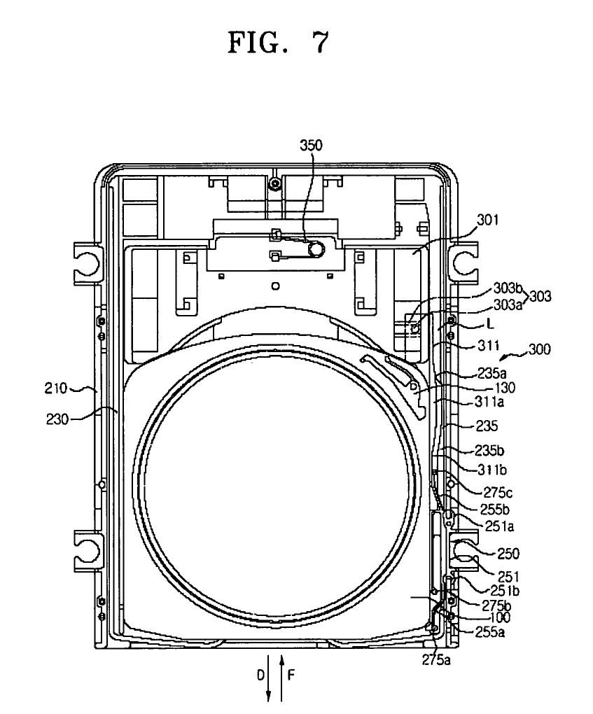

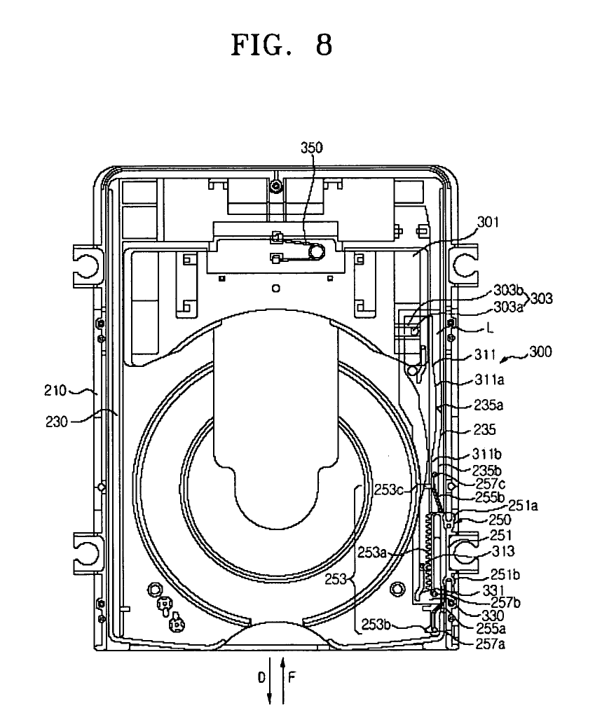

A cam unit 300 is formed on an upper surface of the tray 230 in order to guide the opening/closing operation part 253 of the shutter opening/closing unit 250 toward the disc cartridge 100 as shown in FIGS. 7 and 8 when the disc cartridge 100 is loaded, and to release the guiding of the opening/closing operation 253 as shown in FIG. 4 when the bare disc is loaded.

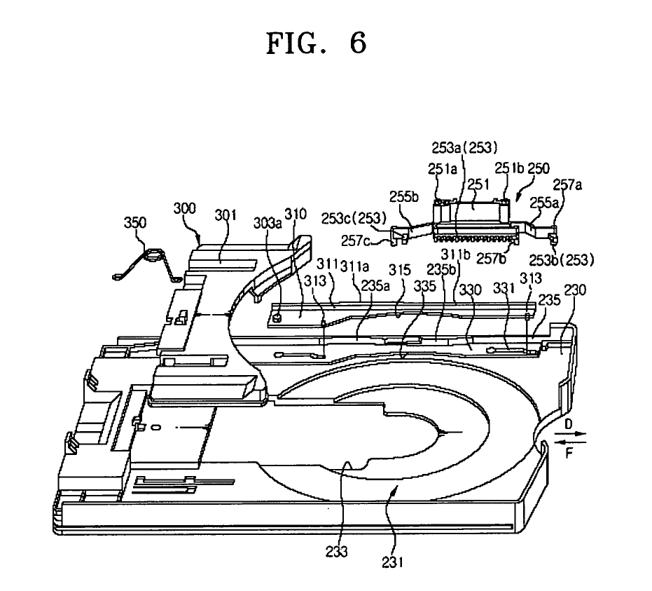

FIG. 6 is an exploded perspective view showing the structure of the cam unit according to an embodiment of the present invention. Referring to FIG. 6, the cam unit 300 comprises a guide rib 235 protruded on an upper surface of the tray 230, a cartridge holder 301 mounted on the tray 230 to reciprocate linearly, a cam slider 310, connected to the cartridge holder 301 through a fixing unit 303, to be moved linearly in association with the reciprocation of the cartridge holder 301, and a guide plate 330 mounted on an upper surface of the tray 230 to guide the movement of the cam slider 310. The cam slider 310 includes a slider rib 311 corresponding in position and shape to the guide rib 235.

The guide rib 235 comprises a recessed part 235a and a protruded part 235b. The recessed part 235a is recessed adjacent to the latch unit 130 in an outward direction with respect to the tray 230. The protruded part 235b is adjacent to the window 111f of the disc cartridge 110 when the disc cartridge 100 is loaded on the tray 230. A shape of the slider rib 311 corresponds to a shape of the inner surface of the guide rib 235 and comprises a slider protruded part 311a and a slider recessed part 311b. As the cam slider 310 moves, positions of the slider protruded part 311a and the recessed part 235a of the guide rib 235 respectively correspond to each other or are separated from each other. Similarly, positions of the slider recessed part 311b and the protruded part 235b of the guide rib 235 respectively correspond to each other or are separated from each other.

The fixing unit 303 comprises a fixing projection 303a formed on the cam slider 310, and fixing ribs 303b, formed at a lower part of the cartridge holder 301, which are disposed at positions allowing for an engagement between the fixing ribs 303b with the fixing projection 303a. Indeed, the fixing projection 303a is interposed between the fixing ribs 303b, as shown in FIG. 4.

A guide projection 313 is formed on a lower part of the cam slider 310. A guide hole 331 is formed on the guide plate 330 where the guide projection 313 is inserted and guided. The guide hole 331 is shaped to gradually approach the tray 230 along a withdrawing direction D of the tray 230. The cartridge holder 301 is resiliently supported on the tray 230 by a resilient member 350. In the above structure, the guide plate 330 and the cam slider 310 respectively have curved parts 335 and 315 having a substantially arc shaped form on inner surfaces thereof to prevent interference with the bare disc.

Hereinbelow, an operational principle of the above-structured disc recording/reproducing apparatus will be described. As shown in FIG. 4, when the bare disc is loaded on the tray 210, the cartridge holder 301 is advanced to a front of the tray 210, that is, in the direction D by the resilient member 350. The cam slider 310 connected to the cartridge holder 301 through the fixing unit 303 is also advanced and accordingly, the slider protruded part 311a of the slider rib 311 is moved to a lower part of the recessed part 235a of the guide rib 235 formed at the tray 230. Therefore, the guide projections 257a, 257b, and 257c of the shutter opening/closing unit 250 are not interfered with by the guide rib 235 and the slider rib 311.

FIG. 7 is a plan view showing the dist cartridge being loaded on a disc loading unit, according to an embodiment of the present invention. FIG. 8 shows a cam unit with the disc cartridge removed, to explain movement of the cam unit where the disc cartridge is being loaded. As shown in FIGS. 7 and 8, when the disc cartridge 100 is loaded on the tray 230, the cartridge holder 301 is moved to an inside of the tray 230 in the direction F and presses the resilient member 350. Accordingly, the cam slider 310 is drawn inwardly with respect to the tray 230, and the slider protruded part 311a and the slider recessed part 311b are moved to positions corresponding to the recessed part 235a and the protruded part 235b of the guide rib 235, respectively to form a guide rail L where the guide projections 257a, 257b, and 257c of the shutter opening/closing unit 250 are contactedly guided.

Where the guide rail L is formed, as the tray 230 enters the main frame 210, the latch unit 130 is unlocked and the rotary wheel 109 is rotated by the shutter opening/closing unit 250. Accordingly, the shutter 107, which covers the opening 111a of the lower case 111, is moved. When the tray 230 is drawn out from the main frame 210 through an unloading operation, the rotary wheel 109 is rotated by the shutter opening/closing unit 250 in the opposite direction, the shutter 107 covers the opening 111a, and the latch unit 30 is again locked.

At this time, since the guide rail L is formed to separate the guide projections 257a, 257b, and 257c from the disc cartridge 100 adjacent to the latch unit 130 of the disc cartridge 100, the rack member 253a of the shutter opening/closing unit 250 is prevented from being interfered with by the latch unit 130.

### Embodiment 2

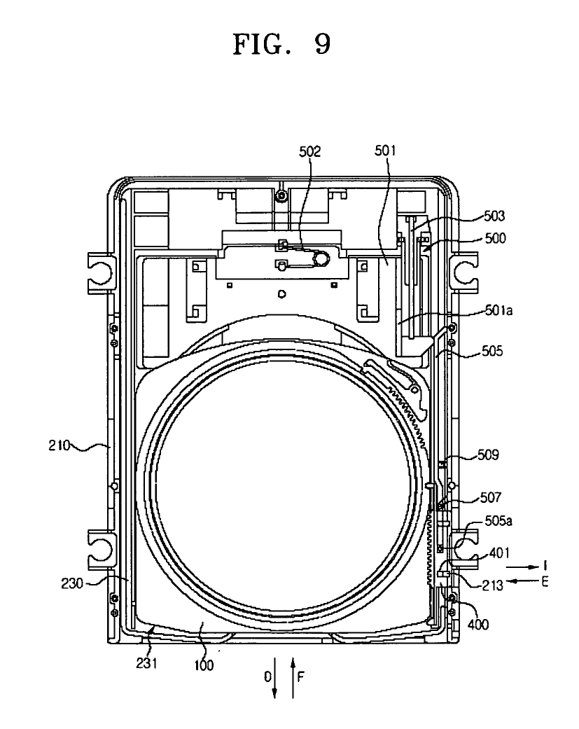

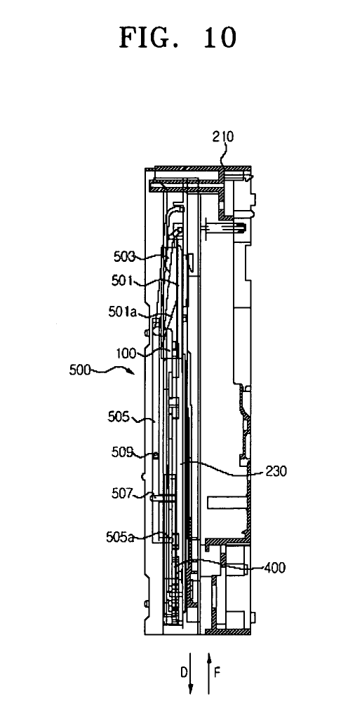

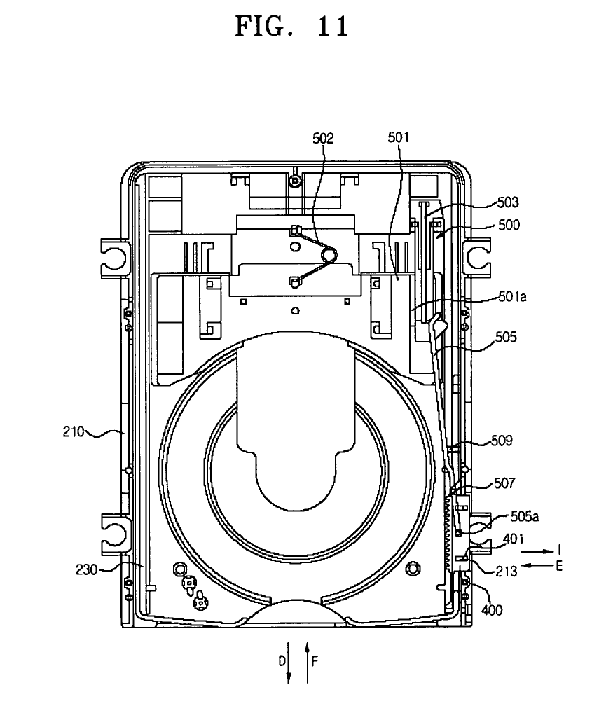

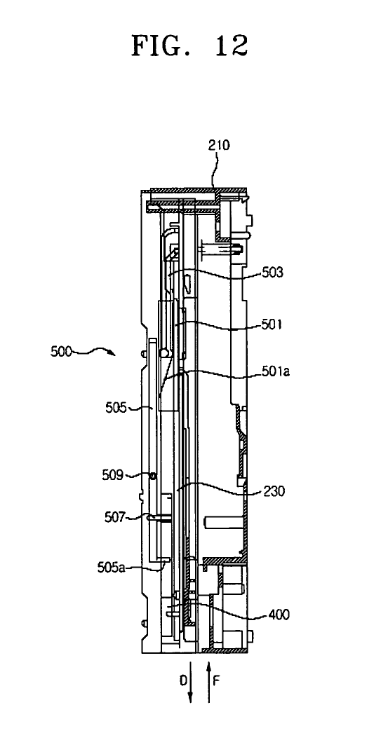

Hereinbelow, another structure to move the shutter opening/closing unit according to a loading state of the bare disc or the disc cartridge will be described. FIG. 9 is a view showing a disc cartridge being loaded on a tray, according to another embodiment of the present invention and FIG. 10 is a side view of FIG. 9. FIG. 11 is a plan view showing a tray with a disc cartridge separated, according to another embodiment of the present invention and FIG. 12 is a side-sectional view. Referring to FIGS. 9 through 12, the tray 230 is mounted on the main frame 210 to reciprocate linearly. The disc loading part 231 is structured in the same manner as described above with reference to FIGS. 4 through 8, in which the bare disc or the disc cartridge 100 is mounted on an upper surface of the tray 230. Therefore, the same elements as described in reference to FIGS. 4 through 8 will be cited by the same reference numerals, and a detailed description thereof will be omitted.

In this embodiment, a shifting unit 500 is provided. When loading the disc cartridge 100 on the tray 230 as shown in FIGS. 9 and 10, the shifting unit 500 moves a shutter opening/closing unit 400 toward the disc cartridge 100. As shown in FIGS. 11 and 12, on the other hand, when loading the bare disc on the tray 210, the shifting unit 500 moves the shutter opening/closing unit 400 outwardly with respect to the tray 230.

The shifting unit 500 comprises a cartridge holder 501 mounted on the tray 230 to reciprocate linearly, an arm 503 mounted at a lower part of the cartridge holder 501 to move vertically in association with the reciprocation of the cartridge holder 501, and a lever 505 supported by the main frame 210 to rotate clockwise and counterclockwise as a result of interference with the arm 503 as the tray 230 reciprocates. The lever 505 is connected by one end to the shutter opening/closing unit 400. The lever 505 is supported by a hinge shaft 507 mounted on the main frame 210 to rotate clockwise and counterclockwise and is connected to the shutter opening/closing unit 400 by a rotation pin 505a mounted at one end thereof.

A slit 401 is formed on a main body of the shutter opening/closing unit 400 while a catch hook 213 to engage with the slit 401 is formed on the main frame 210. Through this structure, the shutter opening/closing unit 400 is supported by the main frame 210 to laterally move in arrowed directions E and 1, as shown in FIG. 11.

One end of the arm 503 is rotatably mounted on the tray 230, and the other end is vertically moved in accordance with the reciprocation of the cartridge holder 501. The vertical motion is guided along a sliding groove 501a formed at the cartridge holder 501. The sliding groove 501a is sloped downward so as to extend to the inner side of the main frame 210, or, in other words, in an arrowed direction F.

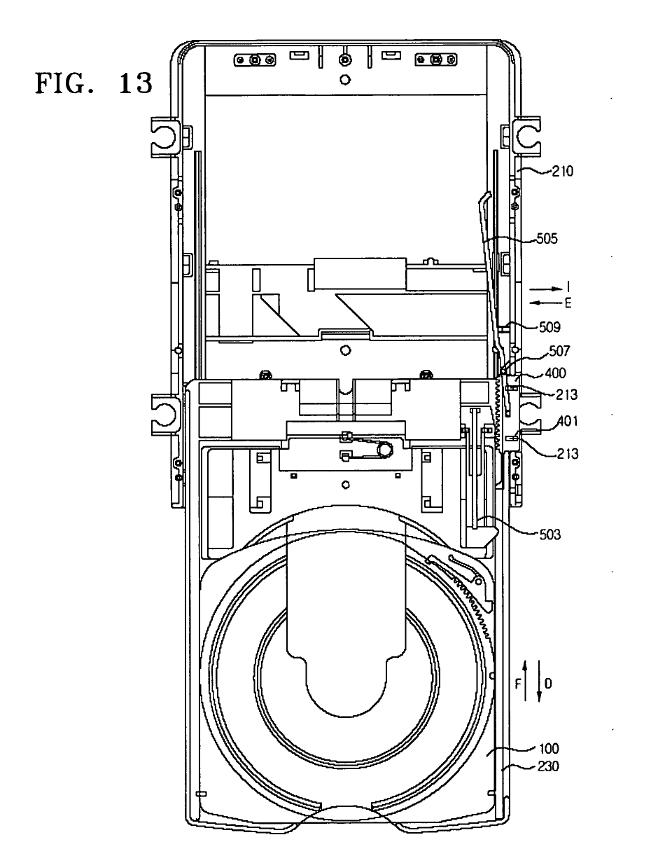

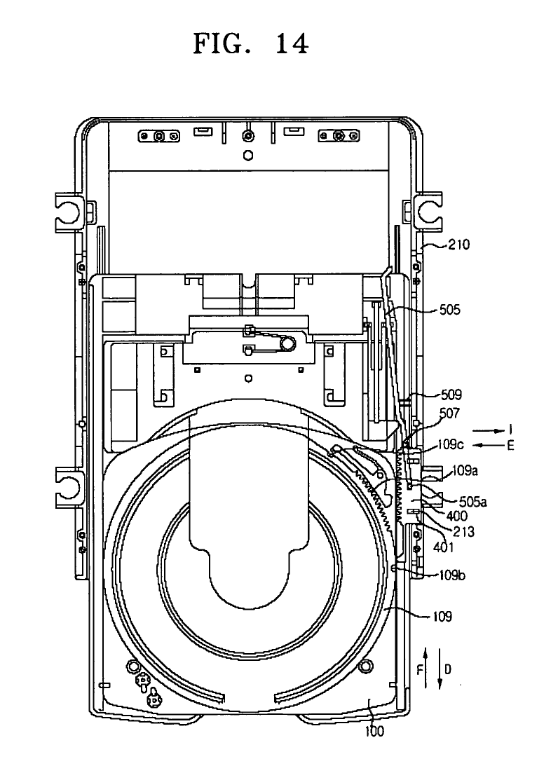

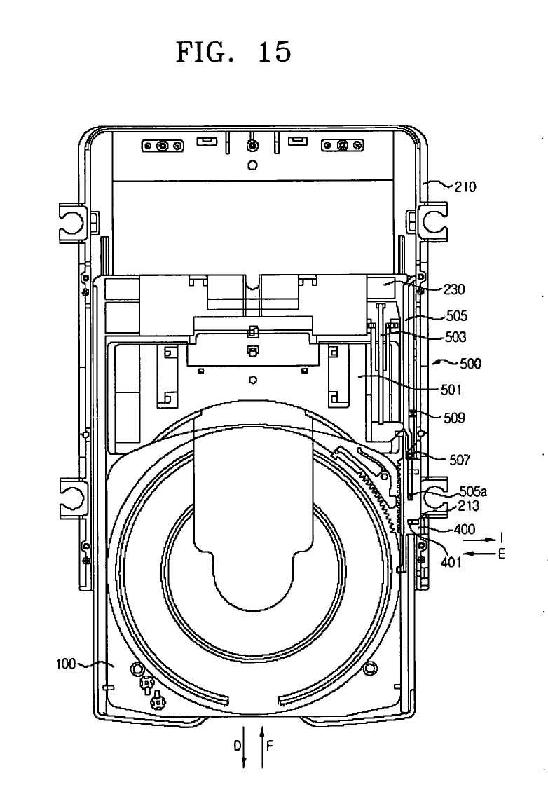

Hereinbelow, the operation of the shifting unit 500 according to the second embodiment of the present invention will be described in greater detail. FIGS. 13 through 15 shows the operation processes of the disc cartridge 100 being loaded on the tray 230 and entering the main frame 210. Referring to FIG. 13 first, when the disc cartridge 100 is loaded on the tray 230, the cartridge holder 501 retreats in the direction F. That is, the cartridge holder 501 retreats in the direction the tray 230 enters the main frame 210 in, and the end of the arm 503 is lifted along the sliding groove 501a (FIG. 11) formed on the cartridge holder 501. Referring to FIG. 14, when the tray 230 advances into the main frame 210, the end of the arm 501 moves in a sliding manner in contact with the lever 505. Simultaneously, the lever 505 is rotated counterclockwise and the shutter opening/closing unit 400 is moved toward the disc cartridge 100. Next, as shown in FIG. 15, when the tray 230 advances into the main frame 210, the shutter opening/closing unit 400 is brought in contact with the opening/closing operation part of the disc cartridge 100. As a result, the first and the second concave cuts 109b and 109c and the segment gear 109a gradually open the shutter 107 of the disc cartridge 100 in the E direction.

As shown in FIG. 9, when the tray 230 is completely received in the main frame 210, the shutter 107 of the disc cartridge 100 is completely opened. Meanwhile, when the bare disc is loaded on the disc loading part 231 as shown in FIGS. 11 and 12, the cartridge holder 501 is resiliently biased by a resilient member 502 in the opposite direction to the direction of the tray 230 advancing into the main frame 210. Therefore, as shown in FIG. 13, the end of the arm 503 is lowered along the sliding groove 501a of the cartridge holder 501 and is separated from the lever 505 not to be interfered with the lever 505. At this time, the lever 505 is inclined to the inside of the tray 230 by resilience of a spring 509. The shutter opening/closing unit 250 connected to the other end of the lever 505 is biased outward in the arrowed direction I with respect to the tray 230 and, accordingly, the catch hook 213 is located on the left of the slit 401 with respect to the drawings.

As described above, in accordance with an aspect of the present invention, a disc recording/reproducing apparatus controls a position of a shutter opening/closing unit according to whether a bare disc or a disc cartridge is loaded therein.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A disc recording/reproducing apparatus, comprising:
a main frame;
a tray, mounted to reciprocate on the main frame, having a disc loading part at an upper surface thereof to mount a disc cartridge or a bare disc;
a shutter opening/closing unit mounted to the main frame to expose and cover an opening of the disc cartridge according to the reciprocation of the tray; and
a cam unit to guide an opening/closing operation part toward the disc loading part when the disc cartridge is loaded on the tray, and to release the guide of the opening/closing operation part when the bare disc is loaded on the tray.

2. The disc recording/reproducing apparatus of claim 1, wherein the cam unit comprises:
a guide rib protruded on an upper surface of the tray;
a cartridge holder mounted to reciprocate on the tray;
a cam slider, connected to the cartridge holder through a fixing unit to move in accordance with the reciprocation of the cartridge holder, having a slider rib corresponding in a position thereof to that of the guide rib; and
a guide plate mounted on the upper surface of the tray to guide the movement of the cam slider.

3. The disc recording/reproducing apparatus of claim 2, wherein the fixing unit comprises:
a fixing projection formed on the cam slider; and
a fixing rib formed on a lower part of the cartridge holder to engage with the fixing projection.

4. The disc recording/reproducing apparatus of claim 2, wherein the cam slider comprises a guide projection at a lower part thereof, and the guide plate comprises a guide hole into which the guide projection is inserted and which guides the guide projection.

5. The disc recording/reproducing apparatus of claim 2, wherein the guide plate comprises a curved part having a substantially arc shaped form on an inner surface thereof to prevent an interference with the bare disc.

6. The disc recording/reproducing apparatus of claim 2, wherein the cam slider comprises a curved part having a substantially arc shaped form on an inner surface thereof to prevent an interference with the bare disc.

7. The disc recording/reproducing apparatus of claim 2, further comprising a resilient member to resiliently bias the cartridge holder on the tray.

8. A disc recording/reproducing apparatus, comprising:
a main frame;
a tray, mounted to reciprocate on the main frame, having a disc loading part at an upper surface thereof, which mounts a disc cartridge or a bare disc;
a shutter opening/closing unit to expose and cover an opening of the disc cartridge according to the reciprocation of the tray; and
a shifting unit to move the shutter opening/closing unit toward the disc loading part when the disc cartridge is loaded on the tray, and to separate the shutter opening/closing unit from the disc loading unit when the bare disc is loaded on the tray.

9. The disc recording/reproducing apparatus of claim 8, wherein the shifting unit comprises:
a cartridge holder mounted to reciprocate on the tray;
an arm mounted at a lower part of the cartridge holder to move vertically in accordance with the reciprocation of the cartridge holder; and
a lever, supported by the main frame to rotate clockwise and counterclockwise as a result of an interference with the arm in accordance with the reciprocation of the tray, connected at one end thereof to the shutter opening/closing unit.

10. The disc recording/reproducing apparatus of claim 9, wherein one end of the arm is rotatably mounted on the tray, and the other end is mounted to move vertically in accordance with the reciprocation of the cartridge holder.

11. The disc recording/reproducing apparatus of claim 10, wherein the cartridge holder comprises a sliding groove to guide the vertical movement of the arm.

12. The disc recording/reproducing apparatus of claim 9, further comprising a resilient member to resiliently bias the cartridge holder on the tray.

13. The disc recording/reproducing apparatus of claim 9, wherein the shutter opening/closing unit comprises a slit, and the main frame comprises a catch hook engaged with the slit.

14. The disc recording/reproducing apparatus of claim 9, further comprising a spring at one side of the lever to resiliently bias the lever inward with respect to the tray.

15. A disc recording/reproducing apparatus, in which a tray, mounted to reciprocate on a main frame, includes a disc loading part at an upper surface thereof on which a disc cartridge or a bare disc is mounted, the apparatus comprising:
a shutter opening/closing unit mounted to the main frame to expose and cover an opening of the disc cartridge according to the reciprocation of the tray when the shutter opening/closing unit is actuated;
an opening/closing part to occupy and move between a first position at which the shutter opening/closing unit is made to be actuated by the opening/closing part and a second position at which the shutter opening/closing unit is not actuated; and
a cam unit to position the opening/closing operation part at the first position when the disc cartridge is loaded on the tray, and to position the opening/closing operation part at the second position when the bare disc is loaded on the tray.

16. The apparatus according to claim 15, wherein the tray comprises a tray opening to expose the bare disc or a disc housed in the disc cartridge.

17. The apparatus according to claim 15, wherein, when the disc cartridge is loaded on the tray, an operative part of the disc cartridge interferes with the opening/closing part.

18. The apparatus according to claim 17, wherein the opening/closing part comprises:
a rack member meshed with a segment gear of the operative part of the disc cartridge; and
first and second shutter opening/closing projections, which interfere with first and second concave cuts and a latch unit of the operative part of the disc cartridge, wherein the rack member and the first and second opening/closing projections are free to move toward and from the disc cartridge.

19. The apparatus according to claim 15, wherein the cam unit comprises:
a guide rib, protruded on an upper surface of the tray, including a recessed part that recesses away from the disc cartridge and a protruded part that protrudes toward the disc cartridge when the disc cartridge is loaded on the tray;
a cartridge holder mounted on the tray to reciprocate linearly,
a cam slider including a slider rib, the slider rib including a slider protruded part and a slider recessed part to respectively correspond in shape with the recessed part and the protruded part of the guide rib, the cam slider being coupled to the cartridge holder through a fixing unit, to be linearly moved in accordance with the reciprocation of the cartridge holder; and
a guide plate mounted on an upper surface of the tray to guide the movement of the cam slider.

20. The apparatus according to claim 19, wherein, as the cam slider moves, positions of the slider protruded part and the recessed part of the guide rib correspond to each other or are separated from each other, and positions of the slider recessed part and the protruded part of the guide rib correspond to each other or are separated from each other.

21. The apparatus according to claim 19, wherein the fixing unit comprises:
a fixing projection formed on the cam slider; and
fixing ribs formed at the cartridge holder, such that the fixing projection is interposed between the fixing ribs.

22. A disc recording/reproducing apparatus, in which a tray, mounted to reciprocate on a main frame, includes a disc loading part at an upper surface on which a disc cartridge or a bare disc is mounted, the apparatus comprising:
a shutter opening/closing unit to expose and cover an opening of the disc cartridge according to the reciprocation of the tray when the shutter opening/closing unit is actuated; and
a shifting unit to move the shutter opening/closing unit toward the disc loading part when the disc cartridge is loaded on the tray, and to separate the shutter opening/closing unit from the disc loading unit when the bare disc is loaded on the tray, wherein the shutter opening/closing unit is actuated when moved toward the disc loading part.

23. The apparatus according to claim 22, wherein the shifting unit comprises:
a cartridge holder mounted on the tray to reciprocate linearly;
an arm, mounted at a lower part of the cartridge holder to move vertically in association with the reciprocation of the cartridge holder, one end of which is rotatably mounted on the tray, the other end being moved vertically, in accordance with the reciprocation of the cartridge holder, and guided along a sliding groove formed at the cartridge holder that is sloped downward so as to extend to an inner side of the main frame; and
a lever, supported by the main frame to rotate clockwise and counterclockwise as a result of an interference with the arm as the tray reciprocates, and connected at one end thereof to the shutter opening/closing unit.

24. The apparatus according to claim 23, further comprising:
a slit formed on the shutter opening/closing unit; and
a catch hook, to engage with the slit, formed on the main frame, such that the shutter opening/closing unit is supported by the main frame to move laterally toward and from the disc cartridge.

25. A disc recording/reproducing apparatus comprising a shifting unit to selectively move a disc cartridge shutter opening/closing unit into an activated position at which the disc cartridge shutter opening/closing unit opens a shutter of a disc cartridge inserted into the disc recording/reproducing apparatus according to whether a bare disc or the disc cartridge is loaded into the disc recording/reproducing apparatus.
